(19) United States
(12) Patent Application Publication
(10) Pub. No.: US 2023/0289538 A1
(43) Pub. Date: Sep. 14, 2023

(54) SYSTEMS AND METHODS FOR CODE-SWITCHED SEMANTIC PARSING

(71) Applicant: Google LLC, Mountain View, CA (US)

(72) Inventors: Rahul Goel, Sunnyvale, CA (US); Shyam Upadhyay, Jersey City, NJ (US); Anmol Agarwal, Ghaziabad (IN)

(21) Appl. No.: 17/981,016

(22) Filed: Nov. 4, 2022

Related U.S. Application Data
(63) Continuation of application No. PCT/US2022/026338, filed on Apr. 26, 2022.

(30) Foreign Application Priority Data
Mar. 10, 2022 (IN) 202241013023

(51) Int. Cl. G06F 40/58; G06F 40/205; G06F 40/30

(52) U.S. Cl. CPC G06F 40/58; G06F 40/205; G06F 40/30

(57) ABSTRACT

Systems and methods for generating code-switched semantic parsing training data and training of semantic parsers. In some examples, a processing system may be configured to use a trained first language model to translate a first single-language text sequence and first parsing data into a second code-switched text sequence and associated second parsing data, and to generate a second training example based on the second code-switched text sequence and the second parsing data. In some examples, the processing system may be further configured to generate a training set from two or more of these second training examples, and to use the training set to train a semantic parser to semantically parse code-switched utterances.

### CROSS-REFERENCE TO RELATED APPLICATIONS

The present application is a continuation of International Application No. PCT/US2022/026338, filed Apr. 26, 2022, which claims priority to Indian Patent Application No. 202241013023, filed Mar. 10, 2022. The present application also claims priority to Indian Patent Application No. 202241013023, filed Mar. 10, 2022. The specifications of each of the foregoing applications are hereby incorporated by reference in its entirety.

### BACKGROUND

Code-switching occurs when a speaker or writer alternates between two or more languages (or two more dialects or other language varieties) within a given utterance (e.g., a sentence fragment, sentence, conversation, etc.). Understanding how to correctly interpret and semantically parse such code-switched utterances is important for the continued development and improvement of voice-based and text-based language models (e.g., automated assistants, translation models). Unfortunately, the majority of existing semantic parsing datasets are in single languages (e.g., English), and generating code-switched training data generally requires time-consuming and expensive human annotations from people who are proficient in multiple languages, or synthetic generation schemes that themselves require very large sets (e.g., 100,000 examples, 200,000 examples, etc.) of human-annotated training data (either in each constituent language, or in the code-switched variety of interest). As such, it can be difficult to obtain sufficient amounts of training data to train a language model to semantically parse a given type of code-switched input, particularly when the code-switching involves languages or combinations thereof that are not particularly common.

### BRIEF SUMMARY

The present technology concerns systems and methods for efficiently generating synthetic code-switched semantic parsing training data, and training of semantic parsers using such training data. In some aspects of the technology, a first language model may be trained to process a single-language utterance with parsing data associating one or more spans of text with one or more identifiers (e.g., slots, intents, span IDs, etc.), and to translate that into a code-switched utterance (e.g., an utterance with words in both English and Spanish, English and Hindi, etc.) with new parsing data associating one or more spans of text in the code-switched utterance with those same identifiers. This first language model may be trained to perform this type of task in any suitable way, and with any suitable data. For example, in some aspects, this first language model may be trained using a relatively small seed set of supervised training data (e.g., 1 example, 5 examples, 10 examples, 100 examples, 500 examples, 1,000 examples, 2,000 examples, 3,000 examples, 5,000 examples, 10,000 examples, etc.) in which each example has a parsed single-language utterance and a parsed code-switched equivalent. This supervised training data may be generated in any suitable way, such as by having human experts (e.g., people familiar with how a given group of speakers tend to blend the languages in question) translating single-language utterances into code-switched utterances, or by having human experts perform quality-control over synthetically generated training examples. A processing system may then be configured to use that trained first language model to generate new synthetic training examples out of a much larger set of parsed single-language utterances by translating each single-language text sequence and its parsing data into a code-switched text sequence and associated parsing data. These synthetically generated code-switched text sequences and their associated parsing data may then be included in a training set, and used to train a semantic parser (e.g., a semantic parser included in a second language model), so that the semantic parser can learn how to directly perform semantic parsing on code-switched utterances similar to those of the training set.

Thus, the present technology enables a relatively small set of initial training data to be used to train a first language model, whose accrued knowledge may then be leveraged to generate large amounts of realistic and accurate synthetic training data. This synthetic training data may in turn be used to directly train further language models to accurately understand and semantically parse code-switched utterances. For example, in some aspects, the present technology may be used to transform a seed set of 100 human-annotated training examples into a full set of 170,000 training examples, and a new language model trained with this full set may parse code-switched inputs 40% better than an equivalent language model trained on the seed set of 100 human-annotated training examples. Further, a language model trained on this full set may parse code-switched inputs as well as an equivalent language model trained on a set of 2,000 human-annotated training examples, thus allowing equivalent performance with 20 times less human-annotated training data. Likewise, in some aspects, the present technology may be used to transform a seed set of 3,000 human-annotated training examples into a full set of 170,000 training examples, and a new language model trained with this full set may parse code-switched inputs 15% better than an equivalent language model trained on the seed set of 3,000 human-annotated training examples. In this way, the present technology allows human experts’ knowledge of a given type of code-switching to be quickly and efficiently extended to generate large amounts of specific training data that can be used to optimize language models to understand utterances that employ that same type of code-switching.

In one aspect, the disclosure describes a computer-implemented method, comprising: for each given first training example of a plurality of first training examples, wherein each first training example of the plurality of first training examples comprises a first text sequence in a single language and first parsing data, and the first parsing data associates each of one or more identifiers with a span of text of the first text sequence: translating, using a trained first language model, the first text sequence of the given first training example into a second text sequence, the second text sequence being a code-switched text sequence in at least two languages; generating, using the trained first language model, second parsing data associating each given identifier of the one or more identifiers with a given span of text of the second text sequence; and generating, using one or more processors of a processing system, a second training example based on the second text sequence and the second parsing data. In some aspects, each identifier of the one or more identifiers corresponds to a semantic tag identified in the first text sequence of the given first training example by a first semantic parser. In some aspects, generating the second training example based on the second text sequence and the second parsing data comprises: generating, using the one or more processors, third parsing data based on the second parsing data; and including, using the one or more processors, the third parsing data in the second training example. In some aspects, each identifier of the one or more identifiers corresponds to a semantic tag identified in the first text sequence of the given first training example by a first semantic parser, and generating the third parsing data based on the second parsing data comprises replacing each given identifier in the second parsing data with the semantic tag that corresponds to the given identifier. In some aspects, each identifier of the one or more identifiers corresponds to a semantic tag identified in the first text sequence of the given first training example by a first semantic parser, and generating the third parsing data based on the second parsing data comprises associating each given identifier in the second parsing data with the semantic tag that corresponds to the given identifier. In some aspects, the first text sequence of the given first training example is in a first language, and the second text sequence is a code-switched text sequence in the first language and a second language. In some aspects, the method further comprises generating a training set from two or more of the generated second training examples. In some aspects, the method further comprises, for each given first training example of the plurality of first training examples: determining, using the one or more processors, a first number of spans of text in the first text sequence of the given first training example that are associated with a first identifier of the one or more identifiers in the first parsing data; determining, using the one or more processors, a second number of spans of text in the second text sequence that are associated with the first identifier of the one or more identifiers in the second parsing data; and excluding, using the one or more processors, the second training example from the training set based on a determination that the first number and the second number are not equal. In some aspects, the method further comprises, for each given first training example of the plurality of first training examples: determining, using the one or more processors, a first list of all of the one or more identifiers included in the first parsing data of the given first training example; determining, using the one or more processors, a second list of all of the one or more identifiers included in the second parsing data; and excluding, using the one or more processors, the second training example from the training set based on a determination that the first list and the second list are not identical. In some aspects, the determination that the first list and the second list are not identical is based on a determination that the second list includes an identifier that is not included in the first list. In some aspects, the method further comprises training a second semantic parser, using the one or more processors, based on the training set. In some aspects, the second semantic parser is part of a second language model.

In another aspect, the disclosure describes a computer program product comprising computer readable instructions that, when executed by a computer, cause the computer to perform one or more of the methods described above.

In another aspect, the disclosure describes a processing system comprising: (1) a memory storing a trained first language model; and (2) one or more processors coupled to the memory and configured to: for each given first training example of a plurality of first training examples, wherein each first training example of the plurality of first training examples comprises a first text sequence in a single language and first parsing data, and the first parsing data associates each of one or more identifiers with a span of text of the first text sequence: translate, using the trained first language model, the first text sequence of the given first training example into a second text sequence, the second text sequence being a code-switched text sequence in at least two languages; generate, using the trained first language model, second parsing data associating each given identifier of the one or more identifiers with a given span of text of the second text sequence; and generate a second training example based on the second text sequence and the second parsing data. In some aspects, each identifier of the one or more identifiers corresponds to a semantic tag identified in the first text sequence of the given first training example by a first semantic parser. In some aspects, the one or more processors being configured to generate the second training example based on the second text sequence and the second parsing data comprises being configured to: generate third parsing data based on the second parsing data; and include the third parsing data in the second training example. In some aspects, each identifier of the one or more identifiers corresponds to a semantic tag identified in the first text sequence of the given first training example by a first semantic parser, and the one or more processors being configured to generate the third parsing data based on the second parsing data comprises being configured to replace each given identifier in the second parsing data with the semantic tag that corresponds to the given identifier. In some aspects, each identifier of the one or more identifiers corresponds to a semantic tag identified in the first text sequence of the given first training example by a first semantic parser, and the one or more processors being configured to generate the third parsing data based on the second parsing data comprises being configured to associate each given identifier in the second parsing data with the semantic tag that corresponds to the given identifier. In some aspects, the one or more processors being configured to translate the first text sequence of the given first training example into the second text sequence comprises being configured to translate the first text sequence in a first language into the second text sequence, the second text sequence being a code-switched text sequence in the first language and a second language. In some aspects, the one or more processors are further configured to generate a training set from two or more of the generated second training examples. In some aspects, the one or more processors are further configured to, for each given first training example of a plurality of first training examples: determine a first number of spans of text in the first text sequence of the given first training example that are associated with a first identifier of the one or more identifiers in the first parsing data; determine a second number of spans of text in the second text sequence that are associated with the first identifier of the one or more identifiers in the second parsing data; and exclude the second training example from the training set based on a determination that the first number and the second number are not equal. In some aspects, the one or more processors are further configured to, for each given first training example of a plurality of first training examples: determine a first list of all of the one or more identifiers included in the first parsing data of the given first training example; determine a second list of all of the one or more identifiers included in the second parsing data; and exclude the second training example from the training set based on a determination that the first list and the second list are not identical. In some aspects, the one or more processors being configured to are further configured to exclude the second training example from the training set based on a determination that the first list and the second list are not identical comprises being configured to exclude the second training example from the training set based on a determination that the second list includes an identifier that is not included in the first list. In some aspects, the one or more processors being configured to are further configured to train a second semantic parser based on the training set. In some aspects, the memory further stores a second language model, and the second semantic parser is part of the second language model.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a flow diagram illustrating the generation a trained language model, and the use of the trained language model to generate a set of code-switched semantic parsing training data, in accordance with aspects of the disclosure.

FIG. 4 sets forth an exemplary method for generating code-switched semantic parsing training data, in accordance with aspects of the disclosure.

FIG. 5 sets forth an exemplary method for generating code-switched semantic parsing training data, in accordance with aspects of the disclosure.

FIG. 6 sets forth an exemplary method for generating a training set based on code-switched semantic parsing training data generated according to the methods of FIGS. 4 or 5, and training a semantic parser based on the training set, in accordance with aspects of the disclosure.

FIG. 7 sets forth an exemplary method for generating a filtered training set based on code-switched semantic parsing training data generated according to the methods of FIGS. 4 or 5, and training a semantic parser based on the training set, in accordance with aspects of the disclosure.

FIG. 8 sets forth an exemplary method for generating a filtered training set based on code-switched semantic parsing training data generated according to the methods of FIGS. 4 or 5, and training a semantic parser based on the training set, in accordance with aspects of the disclosure.

### DETAILED DESCRIPTION

The present technology will now be described with respect to the following exemplary systems and methods. Reference numbers in common between the figures depicted and described below are meant to identify the same features.

### Example Systems

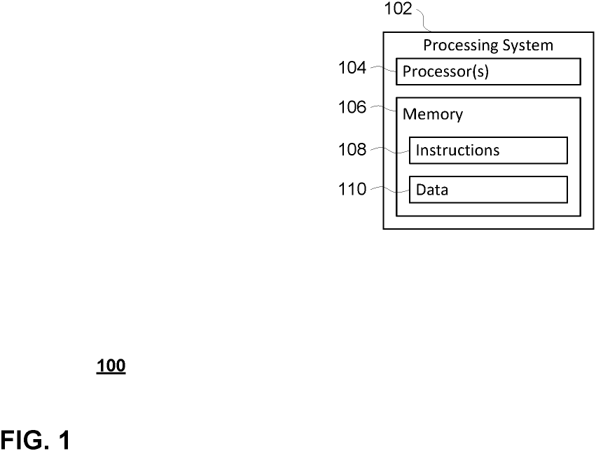

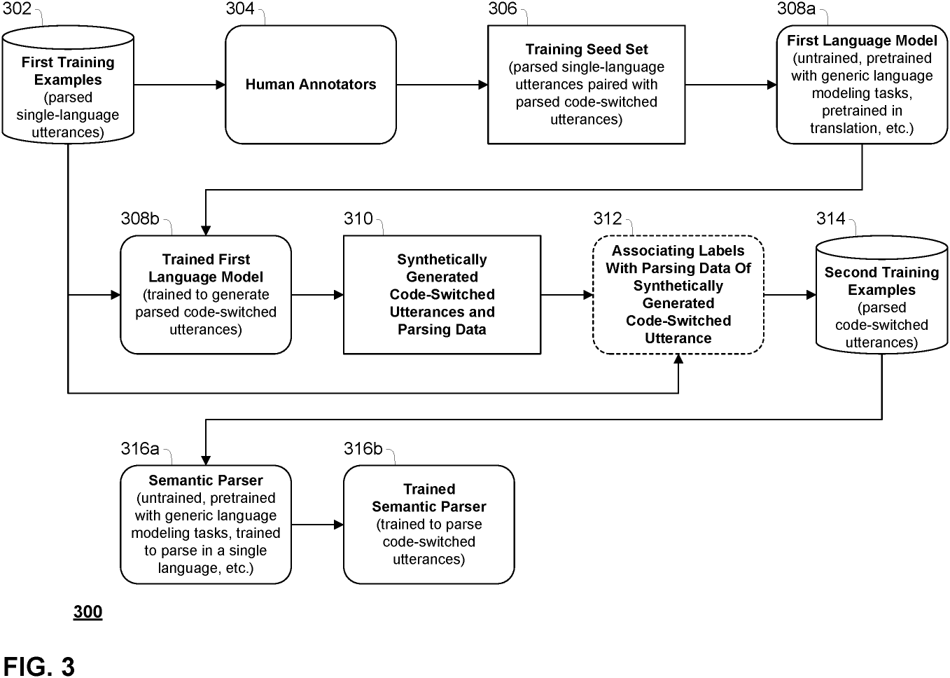

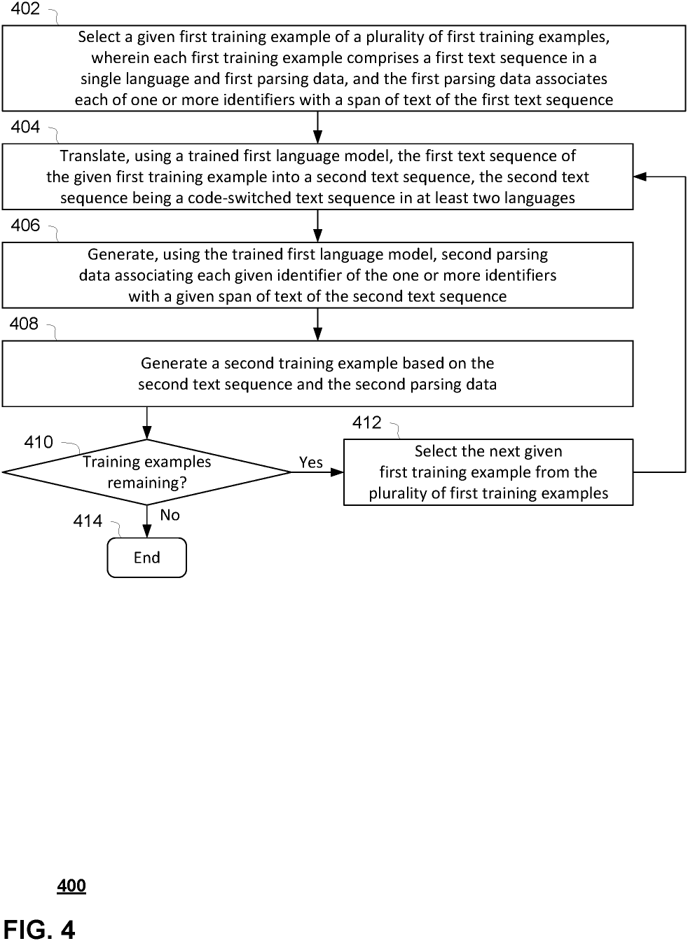

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include one or more language models (e.g., the first language model and/or second semantic parser of FIGS. 3-8). In addition, the data 110 may store training examples to be used in training the language models. For example, data 110 may include training examples used in pre-training the first language model and/or the second semantic parser of FIGS. 3-8, one or more examples used as seed sets for training the first language model (e.g., the plurality of first training examples of FIG. 4), and/or the second training examples described in FIGS. 4-8. Data 110 may further include data generated by the language models during training, such as their responses to each training example, loss values generated based on those responses, etc.

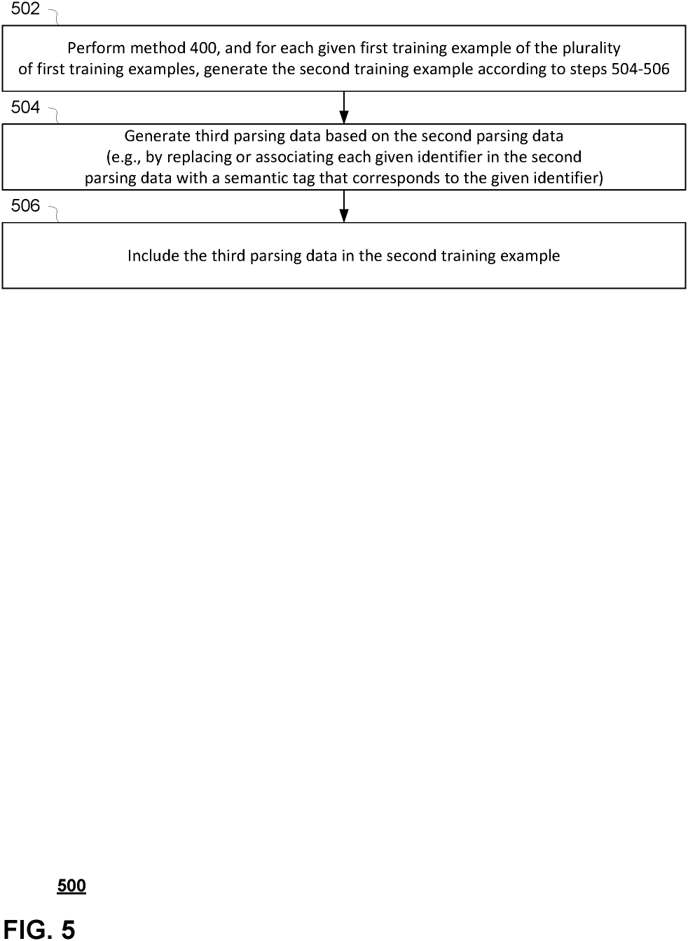

Processing system 102 may be resident on a single computing device. For example, processing system 102 may be a server, personal computer, or mobile device, and one or more language models (e.g., the first language model and/or second semantic parser of FIGS. 3-8) and associated data may thus be local to that single computing device. Similarly, processing system 102 may be resident on a cloud computing system or other distributed system. In such a case, one or more language models (e.g., the first language model and/or second semantic parser of FIGS. 3-8) and associated data may be distributed across two or more different physical computing devices. For example, in some aspects of the technology, the processing system may comprise a first computing device storing a language model (e.g., the first language model and/or the second semantic parser of FIGS. 3-8), and a second computing device storing data used for training the language model and/or training examples generated by the language model. Likewise, in some aspects of the technology, the processing system may comprise a first computing device storing a first language model (e.g., the first language model of FIGS. 3-8), a second computing device storing a second language model (e.g., the second semantic parser of FIGS. 5-8), and a third computing device storing data used for training the first language model and training examples generated by the first language model. Further, in some aspects of the technology, the processing system may comprise a first computing device storing layers 1-n of a first language model (e.g., the first language model of FIGS. 3-8) having m layers, a second computing device storing layers n-m of the first language model, a third computing device storing layers 1-n of a second language model (e.g., the second semantic parser of FIGS. 5-8) having m layers, a fourth computing device storing layers n-m of the second language model, a fifth computing device storing data used for training the first language model, and a sixth computing device storing training examples generated by the first language model.

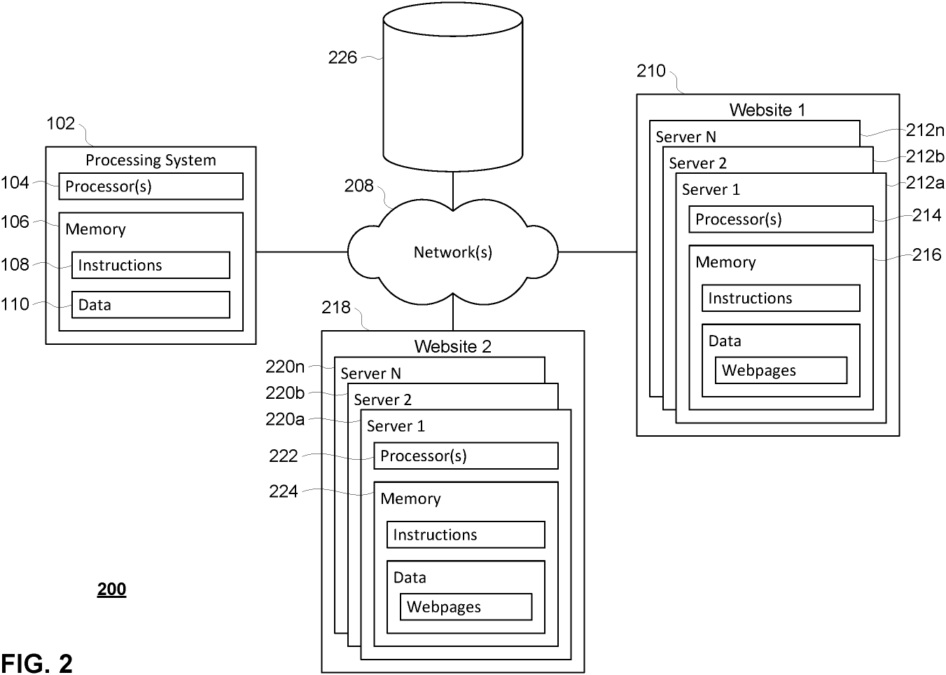

Further in this regard, FIG. 2 shows a high-level system diagram 200 in which the exemplary processing system 102 just described is shown in communication with various websites and/or remote storage systems over one or more networks 208, including websites 210 and 218 and remote storage system 226. In this example, websites 210 and 218 each include one or more servers 212a-212n and 220a-220n, respectively. Each of the servers 212a-212n and 220a-220n may have one or more processors (e.g., 214 and 222), and associated memory (e.g., 216 and 224) storing instructions and data, including the content of one or more webpages. Likewise, although not shown, remote storage system 226 may also include one or more processors and memory storing instructions and data. In some aspects of the technology, the processing system 102 may be configured to retrieve data from one or more of website 210, website 218, and/or remote storage system 226, for use in pretraining or training of a language model (e.g., the first language model and/or second language model of FIGS. 3-8).

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

FIG. 3 is a flow diagram 300 illustrating the generation of a trained language model, and the use of the trained language model to generate a set of code-switched semantic parsing training data, in accordance with aspects of the disclosure.

The exemplary flow depicted in FIG. 3 begins with a set of first training examples 302, each of which includes a parsed single-language utterance. This set of first training examples may be any suitable size, and may be from any suitable source. For example, the set of first training examples may include any suitable number of pre-parsed training examples (e.g., 10,000, 50,000, 100,000, 200,000, 1,000,000, etc.) from one or more publicly available datasets of parsed training examples such as the TOPv2 dataset, the original TOP dataset, the ATIS dataset, or the SNIPS dataset. Likewise, the set of first training examples may include single-language utterances that were originally harvested from one or more datasets of unparsed utterances, and/or from any other suitable unparsed sources such as websites, logs of user queries, etc. In such a case, the unparsed utterances may then be parsed by a first semantic parser (not shown) in order to generate the set of first training examples 302. This first semantic parser may be any suitable heuristic or learned semantic parser, which may be a part of a language model. For example, each of the unparsed utterances may be parsed by a separate language model having the same architecture and initial parameters as the first language model 308a described further below. Likewise, the first semantic parser may be stored on the same processing system as the first language model 308a (e.g. processing system 102), or the first semantic parser may be part of a different processing system such that only its outputs are stored on the same processing system as the first language model 308a. Furthermore, in some aspects of the technology, the set of first training examples 302 may be derived from audio data comprising spoken utterances. For example, a speech-to-text model or utility may be used to convert audio data of spoken utterances into textual utterances, which may then be further parsed as just described.

The set of first training examples 302 may include any suitable type of parsing data. Thus, in some aspects of the technology, the parsing data included in a given first training example may simply associate one or more numerical, textual, or alphanumeric generic identifiers (e.g., ordinal span IDs) with one or more spans of text in the single-language utterance of the given first training example. Likewise, in some aspects, the parsing data included in a given first training example may associate a numerical, textual, or alphanumeric semantic identifier with one or more spans of text in the single-language utterance of the given first training example. For example, a semantic identifier may indicate whether a given span of text in the single-language utterance of the given first training example is an intent (e.g., a request to set an alarm, check traffic, etc.) or a slot (e.g., information relevant to setting the alarm such as time, date, alarm chime; information relevant to checking the traffic such as a geographic zone, destination, time, date, etc.). Further, in some aspects, where the parsing data in each first training example includes one or more semantic identifiers, those semantic identifiers may be converted into generic identifiers (e.g., ordinal span IDs) prior to generating equivalent parsed code-switched utterances.

In the example of FIG. 3, a first portion of the set of first training examples 302 are provided to one or more human annotators 304 to generate a training seed set 306. Any suitable number (e.g., 1, 5, 10, 100, 500, 1,000, 2,000, 3,000, 5,000, 10,000, etc.) or percentage of the set of first training examples 302 may be used to generate the training set 306. The human annotators 304 will be tasked with translating the single-language utterance into an equivalent code-switched utterance. In some aspects of the technology, the single-language utterance may be in a first language, and the code-switched utterance may be a hybrid of the first language and one or more other languages. For example, the human annotators 304 may be tasked with translating a parsed sentence in English into a similarly parsed sentence in a hybrid of Spanish and English, a hybrid of Spanish, Portuguese, and English, or a hybrid of Hindi and English. Likewise, in some aspects of the technology, the single-language utterance may be in a first language, and the code-switched utterance may be a hybrid of two or more other languages. For example, the human annotators 304 may be tasked with translating a parsed sentence in English into a similarly parsed sentence in a hybrid of Spanish and Portuguese. In addition, for each identified span of text in the parsing data of the first training example, the human annotators 304 are also tasked with labeling the corresponding spans of text in the code-switched utterance with the same identifier. Further in that regard, in some aspects of the technology, the human annotators 304 may be tasked with initially converting semantic identifiers in the parsing data of each first training example into generic identifiers (e.g., ordinal span IDs), such that the generic identifiers may then be used when labeling each corresponding span of text in the code-switched utterances. Each of the parsed single-language utterances translated by the human annotators 304 will be paired with the respective code-switched utterance and parsing data created by the human annotators 304 to create a training example of the training seed set 306.

In the example of FIG. 3, the training seed set 306 is then used to train a first language model 308a. The first language model 308a may be any suitable type of language model (e.g., mT5, T5, BERT, LaMDA, GPT-3, etc.), with any suitable architecture and number of parameters. In addition, the first language model 308a may be completely untrained, pretrained with generic language modeling tasks (e.g., masked modeling tasks, next-sentence prediction tasks, sentence completion tasks, etc.), pretrained in translation tasks (e.g., translating between the language used in the single-language utterances of the training seed set 306 and one or more of the languages of the code-switched utterances of the training seed set 306), and/or pretrained using any other suitable type of pre-training task. For example, in some aspects of the technology, the first language model 308a may be a small mT5 multi-lingual text-to-text transformer with 300 million parameters pretrained in multiple languages, or a large mT5 multi-lingual text-to-text transformer with 13 billion parameters pretrained in multiple languages.

As a result of the training, the first language model 308a becomes a trained first language model 308b configured to receive a parsed single-language utterance and generate an equivalent parsed code-switched utterance. Thus, once training has been completed, the trained first language model 308b may then be used, as shown in FIG. 3, to process a second portion of the set of first training examples 302 to generate a set of synthetically generated code-switched utterances and parsing data 310. Here as well, any suitable portion of the first training examples may be used to generate the set of synthetically generated code-switched utterances and parsing data 310. For example, in some aspects of the technology, the entire remainder of the set of first training examples 302 that was not used to generate the training seed set 306 may be used to generate the set of synthetically generated code-switched utterances and parsing data 310. Likewise, in some aspects of the technology, a predetermined number (e.g., 10,000, 50,000, 100,000, 200,000, 1,000,000, etc.) or a predetermined percentage of the remaining first training examples may be used to generate the set of synthetically generated code-switched utterances and parsing data 310.

As shown in the dashed box 312, the trained first language model 308b or a processing system (e.g., processing system 102) may also optionally be configured to associate labels included in the set of first training examples 302 with the synthetically generated code-switched utterances and parsing data 310. For example, as discussed above, where the parsing data in each first training example includes semantic identifiers, the trained first language model 308b or the processing system may be configured to convert those semantic identifiers into generic identifiers (e.g., ordinal span IDs) prior to the trained first language model 308b generating the synthetically generated code-switched utterances and parsing data 310. In such a case, the trained first language model 308b may be configured to generate a set of synthetically generated code-switched utterances and parsing data 310 in which the parsing data uses the generic identifiers. Then, a further component (e.g., a layer, function, etc.) of the trained first language model 308b or the processing system may be configured to associate each generic identifier in the synthetically generated code-switched utterances and parsing data 310 with its corresponding semantic identifier. In some aspects of the technology, each generic identifier in the synthetically generated code-switched utterances and parsing data 310 may be replaced with its corresponding semantic identifier. Likewise, in some aspects of the technology, the synthetically generated code-switched utterances and parsing data 310 may be augmented with data identifying the semantic identifier that corresponds to each generic identifier in the parsing data.

In the example of FIG. 3, each of the synthetically generated code-switched utterances and parsing data 310 (and any modifications made thereto according to the optional processing of box 312) is collected to form a set of second training examples 314. In some aspects of the technology, the set of second training examples may further include one or more of the human-generated code-switched utterances and parsing data of the training seed set 306. The set of second training examples 314 may then be used to train a semantic parser 316a to generate a trained semantic parser 316b that is capable of directly parsing code-switched utterances similar to (e.g., using the same languages as) those included in the set of second training examples 314. The semantic parser 316a may be a dedicated semantic parser or a part of a further language model, and may be the same semantic parser used for initially parsing each of the set of first training examples 302 (as discussed above) or a separate semantic parser. In some aspects of the technology, the semantic parser 316a may be included in a separate language model (not shown) having the same architecture and initial parameters as the first language model 308a described above. Likewise, in some aspects, the semantic parser 316a may be stored on the same processing system as the first language model 308a (e.g. processing system 102), or a different processing system. Where the semantic parser 316a is a part of a language model, the language model may be of any suitable type, with any suitable architecture and number of parameters. Such a language model may be completely untrained, pretrained with generic language modeling tasks (e.g., masked modeling tasks, next-sentence prediction tasks, sentence completion tasks, etc.), pretrained in translation tasks (e.g., translating between the language used in the single-language utterances of the training seed set 306 and one or more of the languages of the code-switched utterances of the training seed set 306), and/or pretrained using any other suitable type of pre-training task. For example, in some aspects of the technology, the semantic parser 316a may be included in a small mT5 multi-lingual text-to-text transformer with 300 million parameters pretrained in multiple languages, or a large mT5 multi-lingual text-to-text transformer with 13 billion parameters pretrained in multiple languages.

FIG. 4 sets forth an exemplary method 400 for generating code-switched semantic parsing training data, in accordance with aspects of the disclosure.

In step 402, a processing system (e.g., processing system 102) selects a given first training example of a plurality of first training examples, wherein each first training example comprises a first text sequence in a single language and first parsing data, and the first parsing data associates each of one or more identifiers with a span of text of the first text sequence. As described further below, the processing system will then perform steps 404-408 for that given first training example. For the purposes of illustrating the steps of method 400, it will be assumed that the given first training example includes a first text sequence of “What’s the traffic like on Long Island going to the Hamptons tonight?” and that the first parsing data associates a numerical identifier with the spans “traffic,” “Long Island,” “the Hamptons,” and “tonight” as follows: “What’s the [traffic]₁ like on [Long Island]₂ going to [the Hamptons]₃ [tonight]₄?”

The plurality of first training examples may be any suitable size, and may include examples from any suitable source, generated in any suitable way, including all options described above with respect to the set of first training examples 302 of FIG. 3. Thus, here as well, the plurality of first training examples may include any suitable number of pre-parsed training examples (e.g., 10,000, 50,000, 100,000, 200,000, 1,000,000, etc.) from one or more publicly available datasets of parsed training examples such as the TOPv2 dataset, the original TOP dataset, the ATIS dataset, or the SNIPS dataset. Likewise, the plurality of first training examples may include first text sequences that were originally harvested from one or more datasets of unparsed utterances, and/or from any other suitable unparsed sources such as websites, logs of user queries, etc. In such a case, the unparsed first text sequences may have been parsed by a first semantic parser (not shown) in order to generate the plurality of first training examples. Where a first semantic parser is employed, it may be any suitable heuristic or learned semantic parser, which may be a part of a language model. For example, a plurality of first text sequences may be parsed by a separate language model having the same architecture and initial parameters as the trained first language model of steps 404 and 406. This first semantic parser may be stored on the same processing system as the trained first language model, or the first semantic parser may be part of a different processing system such that only its outputs are stored on the same processing system as the trained first language model. Furthermore, in some aspects of the technology, the plurality of first training examples may be derived from audio data comprising spoken utterances. For example, a speech-to-text model or utility may be used to convert audio data of spoken utterances into textual utterances, which may then be further parsed as just described.

The first parsing data included in the plurality of first training examples may be of any suitable type and use any suitable type of identifiers. Thus, in some aspects of the technology, the first parsing data included in each given first training example may associate one or more numerical, textual, or alphanumeric generic identifiers (e.g., ordinal span IDs) with one or more spans of text in the first text sequence of the given first training example, such as in the exemplary first text sequence discussed above (“What’s the traffic like on [Long Island]₁ going to [the Hamptons]₂ [tonight]₃?”). Likewise, in some aspects, the first parsing data may include one or more numerical, textual, or alphanumeric semantic identifiers, such as ones that indicate whether a given span of text in the first text sequence of the given first training example is an intent (e.g., a request to set an alarm, check traffic, etc.) or a slot (e.g., information relevant to setting the alarm such as time, date, alarm chime; information relevant to checking the traffic such as a geographic zone, destination, time, date, etc.). For example, the given first text sequence may have initially been parsed by a semantic parser as “What’s the [traffic]_{check_}_{traffic} like on [Long Island]_{zone} going to [the Hamptons]_{destination} [tonight]_{date_}ₜᵢₘₑ.” Further, in some aspects, where the first parsing data in each first training example includes semantic identifiers, the processing system may be further configured to convert those semantic identifiers into generic identifiers (e.g., ordinal span IDs) prior to steps 404 and/or 406, such that the trained first language model may translate the first text sequence and/or generate the second parsing data (as discussed further below) based on the generic identifiers. For example, where the first text sequence is initially parsed as “What’s the [traffic]_{check_}_{traffic} like on [Long Island]_{zone} going to [the Hamptons]_{dtestination} [tonight]_{date_}ₜᵢₘₑ” as just discussed, the processing system may convert the semantic tags “check _traffic,” “zone,” “destination,” and “date_time” to generic numerical identifiers as follows: “What’s the [traffic]₁ like on [Long Island]₂ going to [the Hamptons]₃ [tonight]₄?”

In step 404, the processing system uses a trained first language model to translate the first text sequence of the given first training example into a second text sequence, the second text sequence being a code-switched text sequence in at least two languages. Thus, using the exemplary first text sequence of “What’s the traffic like on Long Island going to the Hamptons tonight?,” the processing system may translate it into a second text sequence in a hybrid of English and Hindi of “Aaj raat Hamptons jaate hue Long Island par traffic kaisa hoga.” Notwithstanding this exemplary illustration, the trained first language model may be configured to perform the translation of step 404 between any suitable combination of languages. Thus, the first text sequence may be in a first language, and the code-switched text sequence may be a hybrid of the first language and one or more other languages. For example, the first text sequence may be in English and the code-switched text sequence may be a hybrid of Spanish and English, a hybrid of Spanish, Portuguese, and English, etc. Likewise, in some aspects of the technology, the first text sequence may be in a first language, and the code-switched text sequence may be a hybrid of two or more other languages. For example, the first text sequence may be in English and the code-switched text sequence may be a hybrid of Spanish and Portuguese.

Here as well, the trained language model may be any suitable type of language model, with any suitable architecture and number of parameters, that has been trained to perform the processing described in steps 404 and 406. For example, in some aspects of the technology, the trained first language model may be a small mT5 multi-lingual text-to-text transformer with 300 million parameters pretrained in multiple languages, or a large mT5 multi-lingual text-to-text transformer with 13 billion parameters pretrained in multiple languages, that has been further trained to receive a parsed single-language utterance and generate an equivalent parsed code-switched utterance. In some aspects of the technology, the trained first language model may have been partially or fully trained using a seed set of human-annotated training examples, such as described above with respect to the training of the first language model 308a of FIG. 3 using the training seed set 306. Likewise, in some aspects, the trained first language model may have been partially or fully trained using a seed set of synthetically generated training examples in which each training example has been checked and confirmed for accuracy by humans. In addition, in some aspects, prior to being trained to generate code-switched utterances, the trained first language model may have been pretrained with generic language modeling tasks (e.g., masked modeling tasks, next-sentence prediction tasks, sentence completion tasks, etc.), translation tasks (e.g., translating between the language used in the first text sequence and the one or more of the second text sequence), and/or any other suitable type of pre-training task.

In step 406, the processing system uses the trained first language model to generate second parsing data associating each given identifier of the one or more identifiers with a given span of text of the second text sequence. Thus, using the exemplary first text sequence of “What’s the traffic like on Long Island going to the Hamptons tonight?,” the processing system may generate second parsing data that associates the numerical identifiers of the first parsing data to corresponding spans of text in the second text sequence as follows: “[Aaj raat]₄ [Hamptons]₃ jaate hue [Long Island]₂ par [traffic]₁ kaisa hoga.”

In step 408, the processing system generates a second training example based on the second text sequence and the second parsing data. Thus, using the exemplary text sequences discussed in each of the prior steps, the processing system may generate a second training example of: {[Aaj raat]₄ [Hamptons]₃ jaate hue [Long Island]₂ par [traffic]₁ kaisa hoga.}. As will be understood, any other suitable formatting may be used to represent the second training example. For example, in some aspects of the technology, the words of the second text sequence may be tokenized, or the words may be broken into one or more wordpieces and tokenized using wordpiece tokenization. Likewise, the second parsing data may use any suitable way of associating the one or more identifiers with each corresponding span of text.

In addition, in some aspects of the technology, the second training example may include information based on the second text sequence and/or the second parsing data, rather than an exact copy of the second text sequence and/or the second parsing data. For example, as discussed further below with respect to FIG. 5, following the generation of the second parsing data in step 406, the trained first language model or a module of the processing system may also optionally be configured to generate third parsing data based on the second parsing data by replacing or associating each of the identifiers of the second parsing data with semantic tags. In such a case, as the third parsing data is generated based on the second parsing data, the second training example may include the third parsing data in place of or in addition to the second parsing data.

In step 410, the processing system determines whether there are any remaining first training examples in the plurality of first training examples. If so, as shown by the “yes” arrow, the processing system will proceed to select the next “given first training example” from the plurality of first training examples in step 412. The steps of 404-412 will then be repeated for that newly selected “given first training example,” and each next one, until the processing system determines at step 410 that there are no first training examples remaining in the plurality of first training examples, and ends at step 414 as shown by the “no” arrow.

FIG. 5 sets forth an exemplary method 500 for generating code-switched semantic parsing training data, in accordance with aspects of the disclosure. As noted above, method 500 sets forth an optional method which may be performed for each given first training example following the generation of its second parsing data in step 406.

Thus, step 502 assumes that method 400 will be performed as described above for each given first training example of the plurality of first training examples, and that steps 504 and 506 will be performed as a part of generating the second training example (step 408) for each given first training example.

In step 504, the trained first language model or a module of the processing system generates third parsing data based on the second parsing data. This may be done in any suitable way. For example, the third parsing data may be generated by replacing each given identifier in the second parsing data with a semantic tag (e.g., a slot or an intent) that corresponds to the given identifier. Likewise, the third parsing data may be generated by associating each given identifier in the second parsing data with a semantic tag (e.g., a slot or an intent) that corresponds to the given identifier.

As discussed above, in some aspects of the technology, a first text sequence may be initially parsed using a first semantic parser to include semantic tags, e.g., tags identifying different types of slots and intents. In such a case, the processing system may be configured to convert those semantic tags into generic identifiers (e.g., ordinal span IDs) prior to steps 404 and/or 406 of FIG. 4. For example, where the first text sequence is initially parsed as “What’s the [traffic]_{check_}_{traffic} like on [Long Island]_{zone} going to [the Hamptons]_{destination} [tonight]_{date_}ₜᵢₘₑ,” the processing system may convert the semantic tags “check_traffic,” “zone,” “destination,” and “date_time” to generic numerical identifiers as follows: “What’s the [traffic]₁ like on [Long Island]₂ going to [the Hamptons]₃ [tonight]₄?” The trained first language model may then translate the first text sequence and generate the second parsing data in steps 404 and 406 (as discussed above) based on the generic identifiers, to arrive at a parsed code-switched utterance of “[Aaj raat]₄ [Hamptons]₃ jaate hue [Long Island]₂ par [traffic]₁ kaisa hoga.” In such a case, step 504 may be performed to generate third parsing data based on the second data, such as by generating third parsing data that replaces or associates the numerical identifiers of the second parsing data with the corresponding semantic tags from the initial semantic parsing.

Thus, in some aspects of the technology, the third parsing data may be a copy of the second parsing data in which each given identifier is replaced with a corresponding semantic tag. For example, the third parsing data may be data that associates the span “Aaj raat” with the slot “date_time,” the span “Hamptons” with the slot “destination,” the span “Long Island” with the slot “zone,” and the span “traffic” with the intent “check_traffic.”

Likewise, in some aspects of the technology, the third parsing data may be data that associates each given identifier with a semantic tag. For example, the third parsing data may associate the identifier “1” with the semantic tag “check_traffic,” the identifier “2” with the semantic tag “zone,” the identifier “3” with the semantic tag “destination,” and the identifier “4” with the semantic tag “date_time.”

In step 506, the processing system includes the third parsing data in the second training example (generated in step 408, as described above). As discussed above, the processing system may include the third parsing data in the second training example in place of or in addition to the second parsing data. For example, using the exemplary second text sequence and second and third parsing data discussed above, where the second and third parsing data are both included, the second training example may be: { [Aaj raat]₄ [Hamptons]₃ jaate hue [Long Island]₂ par [traffic]₁ kaisa hoga; 1|check_traffic; 2|zone; 3|destination; 4|date_time}. Likewise, where only the third parsing data is included, the second training example may be: {[Aaj raat]_{date_}time [Hamptons]_{destination} jaate hue [Long Island]_{zone} par [traffic]_{check_}_{traffic} kaisa hoga}. Here as well, any other suitable formatting may be used to represent the second text sequence and the second and/or third parsing data. For example, in some aspects of the technology, the words of the second text sequence may be tokenized, or the words may be broken into one or more wordpieces and tokenized using wordpiece tokenization. Likewise, the second and/or third parsing data may use any suitable way of associating the one or more identifiers with each corresponding span of text or each corresponding semantic tag.

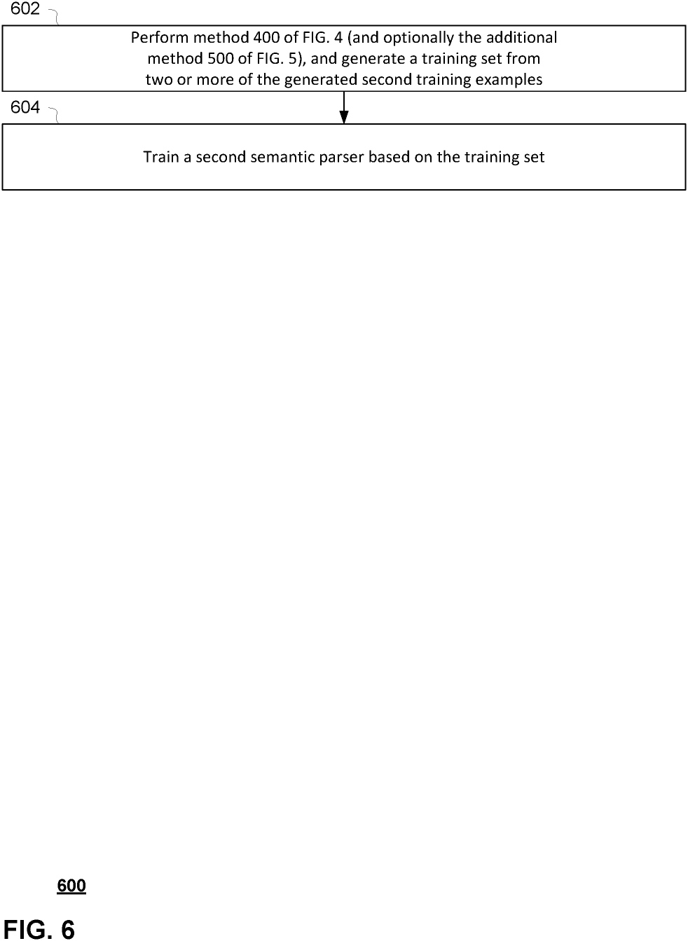

FIG. 6 sets forth an exemplary method 600 for generating a training set based on code-switched semantic parsing training data generated according to the methods of FIGS. 4 or 5, and training a semantic parser based on the training set, in accordance with aspects of the disclosure.

Thus, step 602 assumes that at least method 400, and optionally method 500, will have been performed to generate multiple second training examples. The processing system will then generate a training set from two or more of those generated second training examples.

In step 604, the processing system trains a second semantic parser based on the training set. In this way, the second semantic parser may become configured to directly parse code-switched text sequences similar to (e.g., using the same languages as) those included in the of second training examples. The processing system may train the second semantic parser using any suitable training parameters and loss functions. Thus, in some aspects of the technology, the processing system may break the training set into two or more batches, and perform back-propagation steps between each batch in order to modify one or more parameters of the second semantic parser.

Here as well, the second semantic parser may be a dedicated semantic parser or a part of a language model. In that regard, where a first semantic parser has been used to parse each first text sequence (as discussed above with respect to FIGS. 4 and 5), the second semantic parser may be the same parser as the first semantic parser, or it may be a different semantic parser than the first semantic parser. Likewise, where the second semantic parser is included in a language model, that language model may use any suitable architecture and number of parameters. Thus, in some aspects, the second semantic parser may be included in a separate language model having the same architecture and initial parameters as the trained first language model. Moreover, such a language model may be completely untrained, pretrained with generic language modeling tasks (e.g., masked modeling tasks, next-sentence prediction tasks, sentence completion tasks, etc.), pretrained in translation tasks, and/or pretrained using any other suitable type of pre-training task. For example, in some aspects of the technology, the second semantic parser may be included in a small mT5 multi-lingual text-to-text transformer with 300 million parameters pretrained in multiple languages, or a large mT5 multi-lingual text-to-text transformer with 13 billion parameters pretrained in multiple languages.

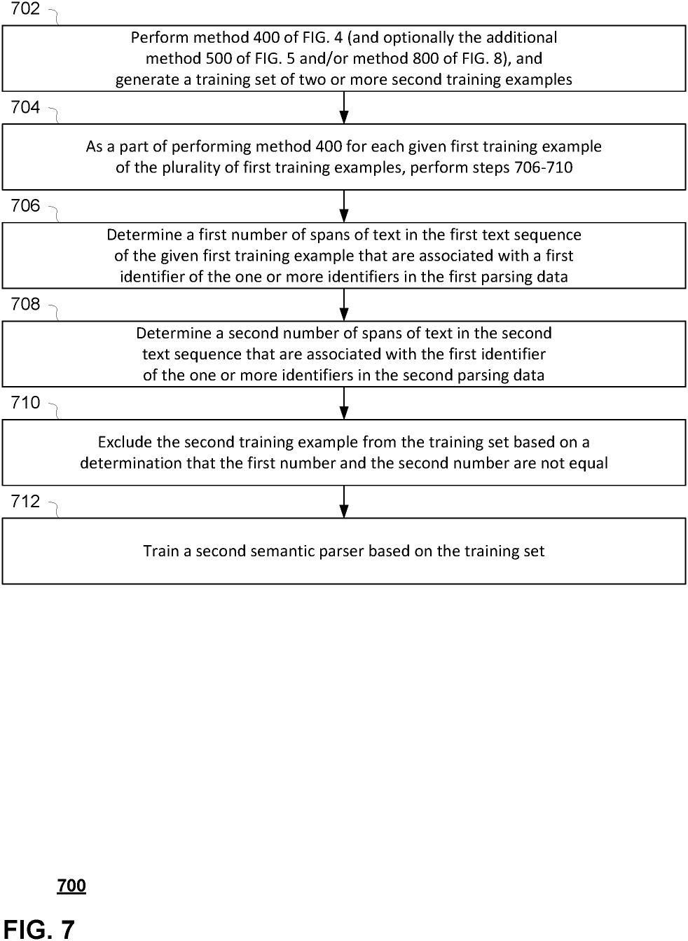

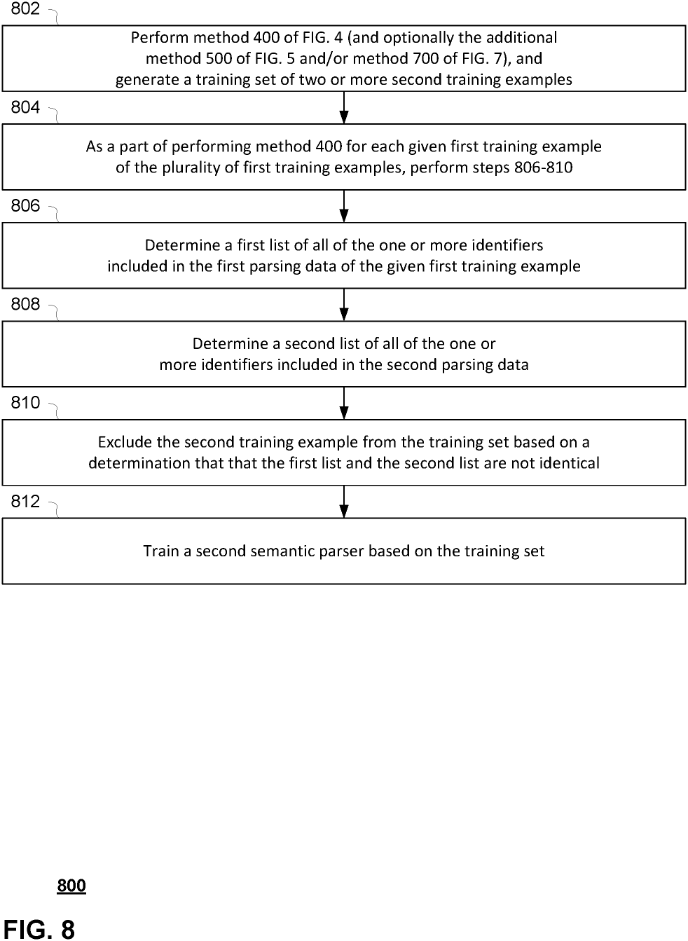

FIG. 7 sets forth an exemplary method 700 for generating a filtered training set based on code-switched semantic parsing training data generated according to the methods of FIGS. 4 or 5, and training a semantic parser based on the training set, in accordance with aspects of the disclosure. In addition, method 700 may be performed in conjunction with method 800 of FIG. 8, discussed below.

Thus, step 702 assumes that at least method 400, and optionally method 500, will have been performed to generate multiple second training examples. In addition, step 702 reflects that method 800 may also optionally have been used to filter those generated multiple second training examples. The processing system then generates a training set from two or more of the resulting second training examples.

As shown in step 704, the processing system will perform steps 706-710 as a part of performing method 400 for each given first training example of the plurality of first training examples. Thus, steps 706-710 will be performed at least once for each given first training example of the plurality of first training examples.

In step 706, the processing system determines a first number of spans of text in the first text sequence of the given first training example that are associated with a first identifier of the one or more identifiers in the first parsing data. To illustrate this, it will be assumed that the first text sequence is “9 pm appointment for photos and remind me an hour before” and the first parsing data associates numerical identifiers with spans of text as follows: “[9 pm]₁ [appointment for photos]₂ and remind [me]₃ [an hour before]₄.” In such a case, the processing system may choose the numerical identifier “3” as the “first identifier,” and thus determine that there is one span of text (“me”) associated with the numerical identifier “3” in the first parsing data. For simplicity of illustration, step 706 makes this determination for only a single identifier. However, in some aspects of the technology, step 706 may be repeated for each of the one or more identifiers in order to count how many spans of text are associated with each of the one or more identifiers in the first parsing data.

In step 708, the processing system determines a second number of spans of text in the second text sequence that are associated with the first identifier of the one or more identifiers in the second parsing data. Using the example from above, the parsed second text sequence may be the following code-switched text sequence in a hybrid of English and Hindi: “[mujhe]₃ [9 pm]₁ ko [photos ke liye appointment]₂ hai aur [mujhe]₃ [ek ghanta pehle]₄ yaad dilaayen.” In such a case, the processing system will determine that there are two spans of text (two instances of “mujhe”) associated with the numerical identifier “3” in the second parsing data. Here as well, in some aspects of the technology, step 708 may be repeated for each of the one or more identifiers in order to count how many spans of text are associated with each of the one or more identifiers in the second parsing data.

In step 710, the processing system excludes the second training example from the training set based on a determination that the first number and the second number are not equal. Thus, although method 400 will result in the processing system generating a second training example based on the second text sequence and second parsing data (e.g., “[mujhe]₃ [9 pm]₁ ko [photos ke liye appointment]₂ hai aur [mujhe]₃ [ek ghanta pehle]₄ yaad dilaayen”), the processing system may exclude this particular second training example from the training set based on the fact that the number of spans of text that are associated with the identifier “3” in the first parsing data is not equal to the number of spans of text that are associated with the first identifier in the second parsing data. Here as well, step 710 may be repeated for each of the one or more identifiers in order to exclude a given second training example if any one of the identifiers in the first parsing data is associated with a different number of spans of text than it is in the second parsing data. Filtering in this way may be helpful to generate a training set that more accurately trains the second semantic parser.

In step 712, the processing system trains a second semantic parser based on the training set. This training make take place in the same way described above with respect to step 604 of FIG. 6. Likewise, the second semantic parser may be configured using any of the options described above with respect to step 604.

FIG. 8 sets forth another exemplary method 800 for generating a filtered training set based on code-switched semantic parsing training data generated according to the methods of FIGS. 4 or 5, and training a semantic parser based on the training set, in accordance with aspects of the disclosure. As noted above, method 800 may also be performed in conjunction with method 700 of FIG. 7.

Thus, step 802 assumes that at least method 400, and optionally method 500, will have been performed to generate multiple second training examples. In addition, step 802 reflects that method 700 may also optionally have been used to filter those generated multiple second training examples. The processing system then generates a training set from two or more of the resulting second training examples.

As shown in step 804, the processing system will perform steps 806-810 as a part of performing method 400 for each given first training example of the plurality of first training examples. Thus, steps 806-810 will be performed at least once for each given first training example of the plurality of first training examples.

In step 806, the processing system determines a first list of all of the one or more identifiers included in the first parsing data of the given first training example. For example, as a first illustration, the first text sequence may be “play [song]₁ [Heart is on fire]₂ on [spotify]₃.” In such a case, the processing system will determine a first list having identifiers “1,” “2,” and “3.” As a second illustration, the first text sequence may be “Remind [me]₁ to [email]₂ [Michelle]₃ [on Tuesday]₄ [about]₅ [the recital]₆.” In such a case, the processing system will determine a first list having identifiers “1,” “2,” “3,” “4,” “5,” and “6.”

In step 808, the processing system determines a second list of all of the one or more identifiers included in the second parsing data. Using the first example from step 806, the parsed second text sequence may be the following code-switched text sequence in a hybrid of English and Hindi: “[spotify]₃ par [song]₁ [Heart is on fire]_{two} ko bajao.” In such a case, the processing system will determine a second list having identifiers “1,” “two,” and “3.” Likewise, using the second example from step 806, the parsed second text sequence may be the following code-switched text sequence in a hybrid of English and Hindi: “[Mujhe]₁ [Tuesday ko]₇ [Michelle]₃ ko [email]₂ karne ke liye yaad dilaayen.” In such a case, the processing system will determine a second list having identifiers “1,” “2,” “3,” and “7.”

In step 810, the processing system excludes the second training example from the training set based on a determination that the first list and the second list are not identical. Thus, using the first example, although method 400 will result in the processing system generating a second training example based on the second text sequence and second parsing data (e.g., “[spotify]₃ par [song]₁ [Heart is on fire]_{two} ko bajao”), the processing system may exclude this particular second training example from the training set based on the fact that the first list includes a “2” that is not in the second list, and the second list includes a “two” that is not in the first list. Likewise, using the example, although method 400 will result in the processing system generating a second training example based on the second text sequence and second parsing data (e.g., “[Mujhe]₁ [Tuesday ko]₇ [Michelle]₃ ko [email]₂ karne ke liye yaad dilaayen”), the processing system may exclude this particular second training example from the training set based on the fact that the first list includes a “4,” a “5,” and a “6” that are not in the second list, and the second list includes a “7” that is not in the first list. Here as well, filtering in this way may be helpful to generate a training set that more accurately trains the second semantic parser.

In step 812, the processing system trains a second semantic parser based on the training set. This training make take place in the same way described above with respect to step 604 of FIG. 6. Likewise, the second semantic parser may be configured using any of the options described above with respect to step 604.

Although methods 700 and 800 describe two exemplary types of filtering, any other suitable type(s) of filtering may be employed, either alone or in conjunction with that which is shown in described in method 700 and/or method 800. For example, in some aspects of the technology, the processing system may filter out second training examples which have formatting irregularities (e.g., an unequal number of opening and closing brackets around the identified spans of text, unusual characters, etc.) that may lead the second semantic parser to incorrectly parse and/or misinterpret the second text sequence or its second parsing data.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method, comprising:
for each given first training example of a plurality of first training examples, wherein each first training example of the plurality of first training examples comprises a first text sequence in a single language and first parsing data, and the first parsing data associates each of one or more identifiers with a span of text of the first text sequence:
translating, using a trained first language model, the first text sequence of the given first training example into a second text sequence, the second text sequence being a code-switched text sequence in at least two languages;
generating, using the trained first language model, second parsing data associating each given identifier of the one or more identifiers with a given span of text of the second text sequence; and
generating, using one or more processors of a processing system, a second training example based on the second text sequence and the second parsing data.

2. The method of claim 1, wherein each identifier of the one or more identifiers corresponds to a semantic tag identified in the first text sequence of the given first training example by a first semantic parser.

3. The method of claim 1, wherein generating the second training example based on the second text sequence and the second parsing data comprises:
generating, using the one or more processors, third parsing data based on the second parsing data; and
including, using the one or more processors, the third parsing data in the second training example.

4. The method of claim 3, wherein each identifier of the one or more identifiers corresponds to a semantic tag identified in the first text sequence of the given first training example by a first semantic parser, and
generating the third parsing data based on the second parsing data comprises replacing each given identifier in the second parsing data with the semantic tag that corresponds to the given identifier.

5. The method of claim 3, wherein each identifier of the one or more identifiers corresponds to a semantic tag identified in the first text sequence of the given first training example by a first semantic parser, and
generating the third parsing data based on the second parsing data comprises associating each given identifier in the second parsing data with the semantic tag that corresponds to the given identifier.

6. The method of claim 1, wherein the first text sequence of the given first training example is in a first language, and the second text sequence is a code-switched text sequence in the first language and a second language.

7. The method of claim 1, further comprising generating a training set from two or more of the generated second training examples.

8. The method of claim 7, further comprising, for each given first training example of the plurality of first training examples:
determining, using the one or more processors, a first number of spans of text in the first text sequence of the given first training example that are associated with a first identifier of the one or more identifiers in the first parsing data;
determining, using the one or more processors, a second number of spans of text in the second text sequence that are associated with the first identifier of the one or more identifiers in the second parsing data; and
excluding, using the one or more processors, the second training example from the training set based on a determination that the first number and the second number are not equal.

9. The method of claim 7, further comprising, for each given first training example of the plurality of first training examples:
determining, using the one or more processors, a first list of all of the one or more identifiers included in the first parsing data of the given first training example;
determining, using the one or more processors, a second list of all of the one or more identifiers included in the second parsing data; and
excluding, using the one or more processors, the second training example from the training set based on a determination that the first list and the second list are not identical.

10. The method of claim 9, wherein the determination that the first list and the second list are not identical is based on a determination that the second list includes an identifier that is not included in the first list.

11. The method of claim 7, further comprising training a second semantic parser, using the one or more processors, based on the training set.

12. The method of claim 11, wherein the second semantic parser is part of a second language model.

13. A processing system comprising:
a memory storing a trained first language model; and
one or more processors coupled to the memory and configured to:
for each given first training example of a plurality of first training examples, wherein each first training example of the plurality of first training examples comprises a first text sequence in a single language and first parsing data, and the first parsing data associates each of one or more identifiers with a span of text of the first text sequence:
translate, using the trained first language model, the first text sequence of the given first training example into a second text sequence, the second text sequence being a code-switched text sequence in at least two languages;
generate, using the trained first language model, second parsing data associating each given identifier of the one or more identifiers with a given span of text of the second text sequence; and
generate a second training example based on the second text sequence and the second parsing data.

14. The processing system of claim 13, wherein each identifier of the one or more identifiers corresponds to a semantic tag identified in the first text sequence of the given first training example by a first semantic parser.

15. The processing system of claim 13, wherein the one or more processors being configured to generate the second training example based on the second text sequence and the second parsing data comprises being configured to:
generate third parsing data based on the second parsing data; and
include the third parsing data in the second training example.

16. The processing system of claim 15, wherein each identifier of the one or more identifiers corresponds to a semantic tag identified in the first text sequence of the given first training example by a first semantic parser, and
wherein the one or more processors being configured to generate the third parsing data based on the second parsing data comprises being configured to replace each given identifier in the second parsing data with the semantic tag that corresponds to the given identifier.

17. The processing system of claim 15, wherein each identifier of the one or more identifiers corresponds to a semantic tag identified in the first text sequence of the given first training example by a first semantic parser, and
wherein the one or more processors being configured to generate the third parsing data based on the second parsing data comprises being configured to associate each given identifier in the second parsing data with the semantic tag that corresponds to the given identifier.

18. The processing system of claim 13, wherein the one or more processors being configured to translate the first text sequence of the given first training example into the second text sequence comprises being configured to translate the first text sequence in a first language into the second text sequence, the second text sequence being a code-switched text sequence in the first language and a second language.

19. The processing system of claim 13, wherein the one or more processors are further configured to generate a training set from two or more of the generated second training examples.

20. The processing system of claim 19, wherein the one or more processors are further configured to, for each given first training example of a plurality of first training examples:
determine a first number of spans of text in the first text sequence of the given first training example that are associated with a first identifier of the one or more identifiers in the first parsing data;
determine a second number of spans of text in the second text sequence that are associated with the first identifier of the one or more identifiers in the second parsing data; and
exclude the second training example from the training set based on a determination that the first number and the second number are not equal.

21. The processing system of claim 19, wherein the one or more processors are further configured to, for each given first training example of a plurality of first training examples:
determine a first list of all of the one or more identifiers included in the first parsing data of the given first training example;
determine a second list of all of the one or more identifiers included in the second parsing data; and
exclude the second training example from the training set based on a determination that the first list and the second list are not identical.

22. The processing system of claim 21, wherein the one or more processors being configured to are further configured to exclude the second training example from the training set based on a determination that the first list and the second list are not identical comprises being configured to exclude the second training example from the training set based on a determination that the second list includes an identifier that is not included in the first list.

23. The processing system of claim 19, wherein the one or more processors being configured to are further configured to train a second semantic parser based on the training set.

24. The processing system of claim 23, wherein the memory further stores a second language model, and the second semantic parser is part of the second language model.

25. A non-transitory computer readable medium comprising instructions which, when executed, cause one or more processors to perform a method comprising:
for each given first training example of a plurality of first training examples, wherein each first training example of the plurality of first training examples comprises a first text sequence in a single language and first parsing data, and the first parsing data associates each of one or more identifiers with a span of text of the first text sequence:
translating, using a trained first language model, the first text sequence of the given first training example into a second text sequence, the second text sequence being a code-switched text sequence in at least two languages;
generating, using the trained first language model, second parsing data associating each given identifier of the one or more identifiers with a given span of text of the second text sequence; and
generating, using one or more processors of a processing system, a second training example based on the second text sequence and the second parsing data.
